(19) United States
(12) Patent Application Publication
(10) Pub. No.: US 2024/0019204 A1
(43) Pub. Date: Jan. 18, 2024

(54) OPERATING COMPRESSORS IN AN INDUSTRIAL FACILITY

(71) Applicant: Saudi Arabian Oil Company, Dhahran (SA)

(72) Inventors: Abdulaziz S. Qurashi, Dhahran (SA); Ahmad G. Alharbi, Dhahran (SA)

(21) Appl. No.: 17/865,114

(22) Filed: Jul. 14, 2022

(51) Int. Cl. F25J 1/02; G05B 13/02

(52) U.S. Cl. CPC F25J 1/0254; G05B 13/0265; F25J 1/0248; F25J 1/0247; F25J 2280/50

(57) ABSTRACT

Systems and methods for operating a natural gas liquids (NGL) plant can include obtaining upstream flow volumes, input flows, and operating conditions of a refinery complex including the NGL plant for a first time period and a second time period. One or more features can be extracted from the upstream flow volumes, input flows, and operating conditions for multiple first time periods and used to form multiple feature vectors. A machine learning model trained with labeled data (e.g., labeled data associating upstream flow volumes, input flows, and operating conditions with incoming feed gas volumes) representing incoming feed gas of the NGL can be used to process the feature vectors to determine predicted incoming feed gas volumes.

### TECHNICAL FIELD

The present disclosure generally relates to operating compressors such as compressors in natural gas liquids (NGL) plants.

### BACKGROUND

NGL plants typical have a series of fractionators whose purpose is to separate a mixture of light hydrocarbons into various pure products. They typically include of one or more demethanizers, deethanizers, depropanizers, debutanizers, and butane splitters. The feed to a NGL Plant typically includes a mixture of light hydrocarbons from an associated Natural Gas Plant. Some NGL plants use the methane stream they generate as fuel for its heating value or as feedstock to a methane reformer for the production of synthesis gas (a mixture of carbon monoxide and hydrogen). The operating objectives of an NGL plant typically balance maximizing through-put while maintaining product quality and optimizing product specifications versus utility costs.

### SUMMARY

This specification describes systems and methods for managing operational strategies for efficiently running compression trains in industrial facilities (e.g., NGL plants). These systems and methods use supervised machine learning algorithms (e.g., regression and decision tree models) to develop the operational strategies. These systems and methods have been used to develop a prototype system predicting incoming feed gas volumes, identifying optimum number of running trains required, and estimating the optimal recycle rates. The developed prototype also advises plant operators whether to shut down compressor trains, maintain existing operations, or start-up new compressor trains.

Some methods for operating a natural gas liquids (NGL) plant include: (a) obtaining upstream flow volumes, input flows, and operating conditions of a refinery complex including the NGL plant for a first time period and a second time period; (b) determining one or more features to extract from the upstream flow volumes, input flows, and operating conditions for each of the first time period and the second time period; (c) extracting the one or more features from the upstream flow volumes, input flows, and operating conditions of the NGL to form a first feature vector for the first time period and a second feature vector for the second time period; (d) processing the first feature vector and the second feature vector using a machine learning model, the machine learning model being trained with labeled data representing incoming feed gas of the NGL, the labeled data associating upstream flow volumes, input flows, and operating conditions with incoming feed gas volumes; and (e) determining, based on the processing, predicted incoming feed gas volumes.

Some methods for operating a natural gas liquids (NGL) plant include: (a) applying a supervised machine learning model to upstream flow volumes, input flows, and operating conditions of the NGL plant for a first time period, the upstream flow volumes, input flows, and operating conditions being associated with incoming feed gas volumes to develop a model predicting incoming feed gas volumes based on a subset of features from the upstream flow volumes, input flows, and operating conditions of the NGL plant; (b) extracting the subset of features from the upstream flow volumes, input flows, and operating conditions of the NGL for a second time period to predict incoming feed gas volumes; and (f) controlling operation of compressors of the NGL plant based on the predicted incoming feed gas volumes.

These methods can include one of more of the following features.

Obtaining upstream flow volumes, input flows, and operating conditions of the NGL plant can include obtaining condensate, ambient temperature and H2S readings.

The methods can also include controlling operation of compressors of the NGL plant based on the predicted incoming feed gas volumes. Controlling operation of compressors of the NGL plant based on the predicted incoming feed gas volumes can include shutting down at least one compression train if the capacity of running compression trains exceeds the predicted incoming feed gas by the capacity of at least one compression train. Controlling operation of compressors of the NGL plant based on the predicted incoming feed gas volumes can include starting up at least one compression train if the capacity of running compression trains is less than the predicted incoming feed gas by the capacity of at least one compression train.

The methods can also include evaluating starting a second train by assessing whether reducing the recycle rate can provide needed additional capacity.

The methods can also include periodically updating feature vectors based new upstream flow volumes, input flows, and operating conditions of the NGL.

The methods can also include repeating step (e) while plant operations are continuing.

These systems and methods can reduce the uncertainty associated with estimating the incoming feed gas/off-gas volumes to a compression facility. This reduction in uncertainty can reduce deviations from optimal compressor recycle rates, missed opportunities of meeting planned preventive maintenance, and artificially imposed urgency during operations.

The details of one or more embodiments of these systems and methods are set forth in the accompanying drawings and the description below. Other features, objects, and advantages of these systems and methods will be apparent from the description and drawings, and from the claims.

### DESCRIPTION OF DRAWINGS

FIG. 1 is a schematic of a NGL plant.

FIG. 2 is a schematic illustrating an example system used to implement processes for controlling compressors in an NGL plant.

FIG. 3 is a diagram illustrating an example computer system 300 configured to execute a machine learning model.

FIG. 4 is a flowchart illustrating operation of a feed gas prediction module.

FIG. 5 is a flowchart illustrating operation of the system of FIG. 2.

FIG. 6 is a chart comparing actual and predicted incoming feed gas volumes of generated by the feed gas prediction module of a prototype system using a training data set.

FIG. 7 is a chart comparing actual and predicted incoming feed gas volumes of generated by the feed gas prediction module of the prototype system using a testing data set.

FIG. 8 is a chart comparing actual incoming feed gas and the capacity of actual running compression trains.

FIG. 9 is a chart comparing predicted incoming feed gas and the capacity of actual running compression trains.

FIG. 10 is a chart comparing predicted incoming feed gas with a 15% recycle rate and the capacity of compression trains that would be to achieve peak efficiency.

FIG. 11 compares the actual running compression trains and the capacity of compression trains that would be operated based results of the compressor operation module of the prototype system.

FIG. 12 compares the actual running compression trains and the capacity of compression trains that would be operated based results of the compressor operation module of the prototype system.

FIG. 13 is a block diagram illustrating an example computer system used to provide computational functionalities associated with described algorithms, methods, functions, processes, flows, and procedures according to some implementations of the present disclosure.

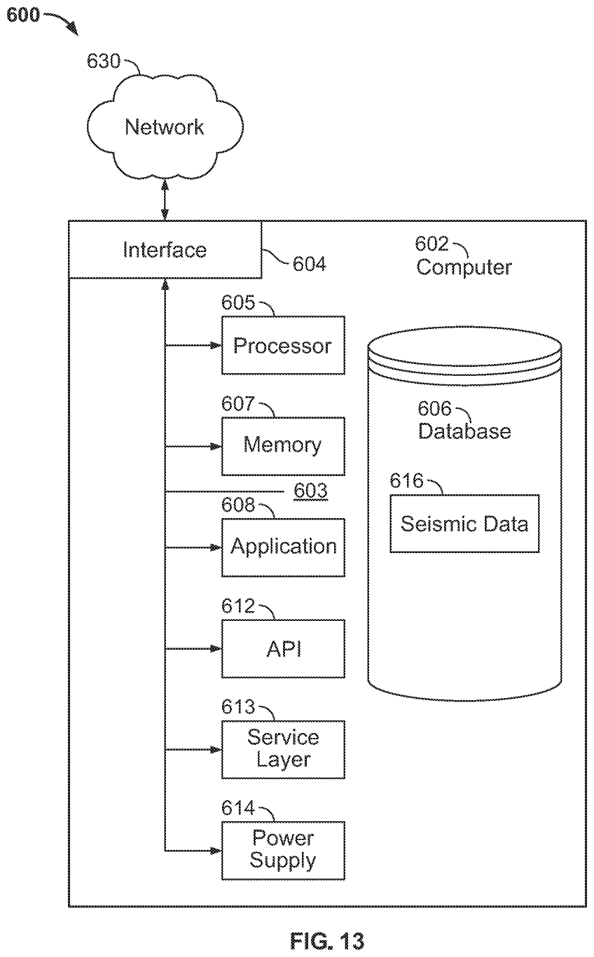

Like reference symbols in the various drawings indicate like elements.

### DETAILED DESCRIPTION

This specification describes systems and methods for managing operational strategies for efficiently running compression trains in industrial facilities (e.g., NGL plants). These systems and methods use supervised machine learning algorithms (e.g., regression and decision tree models) to develop the operational strategies. These systems and methods have been used to develop a prototype system predicting incoming feed gas volumes, identifying optimum number of running trains required, and estimating the optimal recycle rates. The developed prototype also advises plant operators whether to shut down compressor trains, maintain existing operations, or start-up new compressor trains.

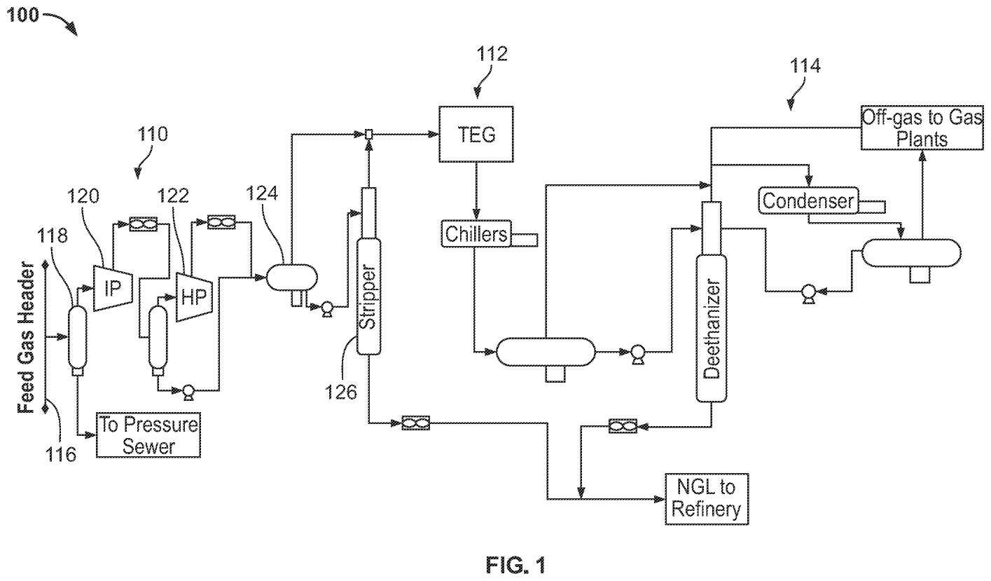

FIG. 1 is a schematic of a NGL plant 100. Atypical NGL Plant 100 includes one or more compression trains 110, stripping fractionation 112, and a de-ethanization section 114. The compression trains 110 take suction from a common network of feed gas header 116. The feed gas is initially passed through feed gas scrubber drums 118 where accumulated liquid is knocked at the bottom. The vapor gas compressed by LP-compressors 120 and partially condensed in inter-stage coolers. The stream separated into hydrocarbon liquid, hydrocarbon vapor and water at the inter-stage separator drums. The hydrocarbon liquid joins the feed to stripping fractionation section. The overhead vapor is further compressed in an HP-compressor 122 and partially condensed in after coolers. The stream separated into hydrocarbon liquid, hydrocarbon vapor and water at stripper feed drums 124. The hydrocarbon condensates are fed to a stripper 126 and most of propane and heavier hydrocarbons (C³+) are separated as bottom product and cooled at the bottom cooler. The bottom product is routed to a refinery under the system pressure. Remaining of propane and almost all of ethane and lighter components (including H²S and CO²) are separated as overhead gases. The overhead gases are routed to the de-ethanizer feed system and then to gas plants for further processing.

Efficient operation of NGL plants is highly dependent on accurate prediction of incoming feed gas volumes and characteristics. Refinery operations departments typically generate short range operating plan data for oil and natural gas plants upstream of an NGL plant, for example, about a month in advance. This data can include estimates of total incoming crude oil and specific lighter hydrocarbon components. These parameters of upstream plants impact the volumes and characteristics of feed gas received by the NGL plant but are not directly related to the volumes and characteristics of feed gas received by the NGL plant. The accurate and precise incoming feed gas predictions provided by the systems and described in this specification can reduce the uncertainties associated with NGL plant operations. This reduction is significant because the uncertainty associated with estimating the incoming feed gas rate can result in deviations from optimal compressor recycle rates, missed opportunities of meeting planned preventive maintenance, and imposed urgency during operations.

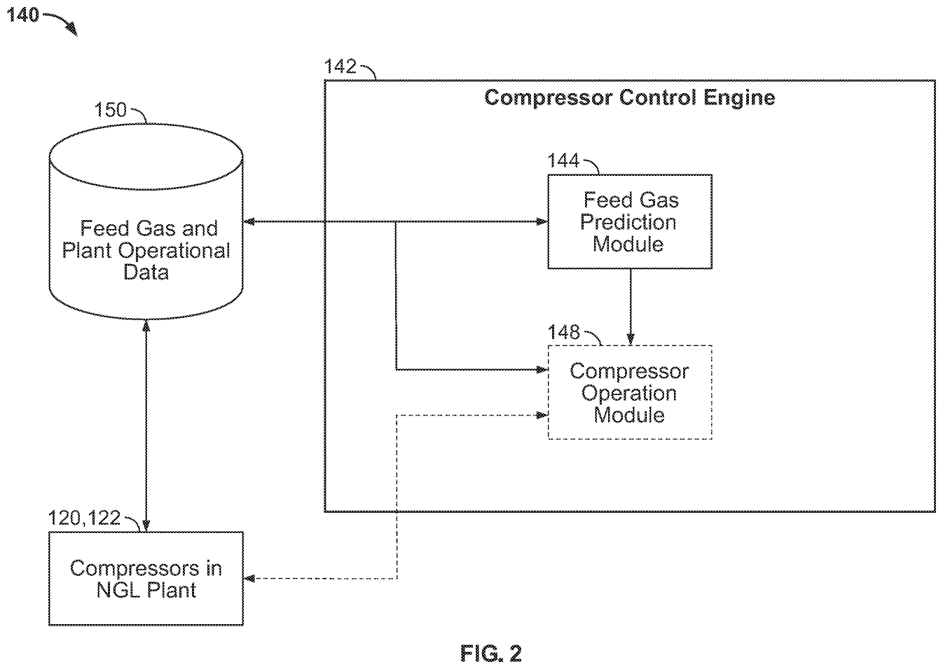

FIG. 2 is a schematic illustrating an example system used to implement processes for controlling compressors in an NGL plant. Modules of the system and communication between modules is described with reference to this figure but the actual implementations of the individual modules are described later in this specification. Some systems are implemented with different modules and/or different communication between modules.

The system 140 can be implemented in computer processors located in a control center of a NGL plant. The system 140 includes a compressor control engine 142 which includes feed gas prediction module 144 and a n optional compressor operation module 148. The compressor control engine 142 is in communication with a data store 150 that contains upstream flow volumes, input flows, and operating conditions of the NGL plant. In some systems, the compressor control engine 142 (e.g., through Supervisory Control and Data Acquisition (SCADA) systems) communicates with compressors 120, 124 of the NLG plant 100. Some systems include more or fewer data stores and/or organize input and output data differently.

The upstream flow volumes, input flows, and operating conditions stored in the data store 150 are provided to the feed gas prediction module 144. The feed gas prediction module 144 includes one or more machine learning models based on historical data associating upstream flow volumes (e.g., total crude volume, Arab Light (AL) crude volume, Arab Extra Light (AXL) crude volume, gas condensate (GC) volume), input flows, and operating conditions with specific volumes and characteristics feed gas of feed gas arriving at the NGL plant 100. The feed gas prediction module 144 determines predicted incoming feed gas volumes to identify optimum number of running trains required as well as estimating the optimal recycle rate. The predicted incoming feed gas volumes stored in the data store 150 and provided to the compressor operation module 148 as input.

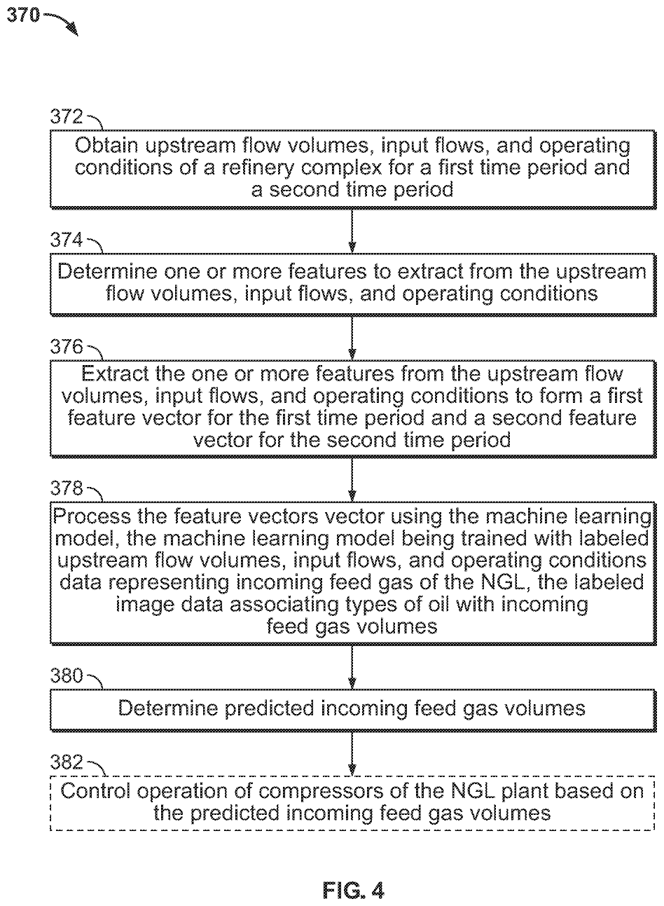

The compressor operation module 148 includes one or more machine learning models based on historical data associating upstream flow volumes, input flows, and operating conditions with specific volumes and characteristics feed gas of feed gas arriving at the NGL plant 100. The compressor operation module 148 receives and processes the upstream flow volumes, input flows, and operating conditions to determine the compressor operation strategies as described in more detail with reference to FIG. 4.

In the illustrated system 140, the compressor control engine 142 sends instructions to the compressors 120, 122. In operation, the compressors 154 generate data that is communicated back to the data store 150 and the compressor control engine 142. This operational data can be used to supplement and confirm the results of the feed gas prediction module 144 and the compressor operation module 148.

In some systems, the predicted feed gas is being used only in the planning stage to inform the operation of how many trains should be operated as well as estimating the optimal recycle rate in the upcoming month based on the forecast shared by Oil Supply Planning and Scheduling department (OSPAS) a month ahead. It is anticipated that incorporating the prediction model into the compressor control engine will be done in a later stage. In these systems, there is no communication between compressor control engine and the prediction model. For example, operations planning can include getting short range operation plan data from OSPAS a month ahead and providing this data as model input. Inserting the stabilization depth of H₂S and IP/LP flow by assuming monthly average. Calculating the predicted amount of feed gas incoming to NGL plant using the model. Calculating optimum recycle rate and number of running trains based on the predicted feed gas and providing the results with plant operators for implementation.

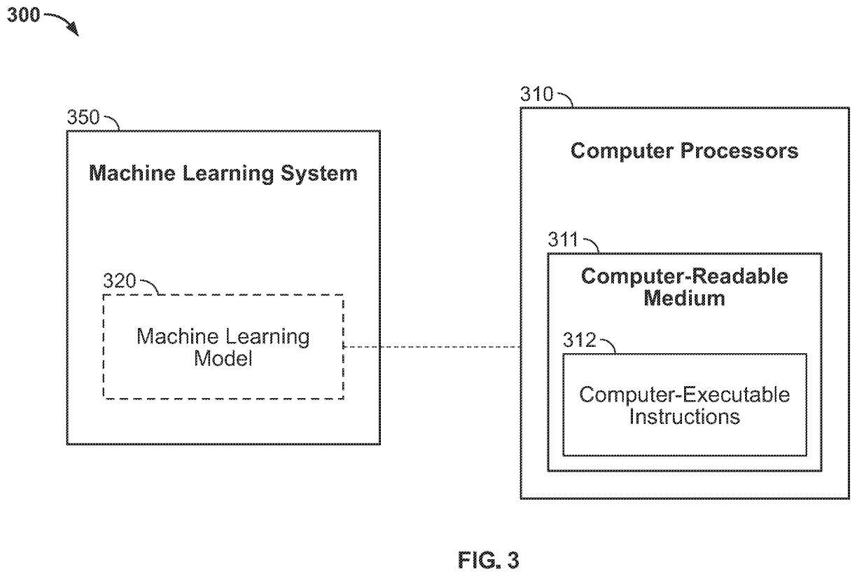

FIG. 3 is a diagram illustrating an example computer system 300 configured to execute a machine learning model. Generally, the computer system 300 is configured to process data (e.g., upstream flow volumes, input flows, and operating conditions) indicating the volume and characteristics of feed gas arriving at the NGL plant 100. The system 300 includes computer processors 310. The computer processors 310 include computer-readable memory 311 and computer readable instructions 312. The system 300 also includes a machine learning system 350. The machine learning system 350 includes a machine learning model 320. The machine learning model 320 can be separate from or integrated with the computer processors 310.

The computer-readable medium 311 (or computer-readable memory) can include any data storage technology type which is suitable to the local technical environment, including but not limited to semiconductor based memory devices, magnetic memory devices and systems, optical memory devices and systems, fixed memory, removable memory, disc memory, flash memory, dynamic random-access memory (DRAM), static random-access memory (SRAM), electronically erasable programmable read-only memory (EEPROM) and the like. In an embodiment, the computer-readable medium 311 includes code-segment having executable instructions.

In some implementations, the computer processors 310 include a general purpose processor. In some implementations, the computer processors 310 include a central processing unit (CPU). In some implementations, the computer processors 310 include at least one application specific integrated circuit (ASIC). The computer processors 310 can also include general purpose programmable microprocessors, graphic processing units, special-purpose programmable microprocessors, digital signal processors (DSPs), programmable logic arrays (PLAs), field programmable gate arrays (FPGA), special purpose electronic circuits, etc., or a combination thereof. The computer processors 310 are configured to execute program code means such as the computer-executable instructions 312 and configured to execute executable logic that includes the machine learning model 320.

The computer processors 310 are configured to receive data including: gas condensate, ambient temperature and H₂S readings. The machine learning model 320 of the feed gas prediction module 144 is capable of processing the data to predict volumes and characteristics of feed gas at the NGL plant 100.

The machine learning system 350 is capable of applying machine learning techniques to train the machine learning model 320. As part of the training of the machine learning model 320, the machine learning system 350 forms a training set of input data by identifying a positive training set of input data items that have been determined to have the property in question, and, in some embodiments, forms a negative training set of input data items that lack the property in question.

The machine learning system 350 extracts feature values from the input data of the training set, the features being variables deemed potentially relevant to whether or not the input data items have the associated property or properties. An ordered list of the features for the input data is herein referred to as the feature vector for the input data. In one embodiment, the machine learning system 350 applies dimensionality reduction (e.g., via linear discriminant analysis (LDA), principle component analysis (PCA), or the like) to reduce the amount of data in the feature vectors for the input data to a smaller, more representative set of data.

In some implementations, the machine learning system 350 uses supervised machine learning to train the machine learning models 320 with the feature vectors of the positive training set and the negative training set serving as the inputs. Different machine learning techniques-such as linear support vector machine (linear SVM), boosting for other algorithms (e.g., AdaBoost), neural networks, logistic regression, naïve Bayes, memory-based learning, random forests, bagged trees, decision trees, boosted trees, or boosted stumps—may be used in different embodiments. The machine learning model 320, when applied to the feature vector extracted from the input data item, outputs an indication of whether the input data item has the property in question, such as a Boolean yes/no estimate, or a scalar value representing a probability.

In some embodiments, a validation set is formed of additional input data, other than those in the training sets, which have already been determined to have or to lack the property in question. The machine learning system 350 applies the trained machine learning model 320 to the data of the validation set to quantify the accuracy of the machine learning model 320. Common metrics applied in accuracy measurement include: Precision=TP/(TP+FP) and Recall=TP/(TP+FN), where precision is how many the machine learning model correctly predicted (TP or true positives) out of the total it predicted (TP+FP or false positives), and recall is how many the machine learning model correctly predicted (TP) out of the total number of input data items that did have the property in question (TP+FN or false negatives). The F score (F-score=2*PR/(P+R)) unifies precision and recall into a single measure. In one embodiment, the machine learning module iteratively re-trains the machine learning model until the occurrence of a stopping condition, such as the accuracy measurement indication that the model is sufficiently accurate, or a number of training rounds having taken place.

In some implementations, the machine learning model 320 is a convolutional neural network (CNN). A CNN can be configured based on a presumption that inputs to the CNN correspond to image pixel data for an image or other data that includes features at multiple spatial locations. For example, sets of inputs can form a multi-dimensional data structure, such as a tensor, that represent color features of an example digital image (e.g., a biological image of biological tissue). In some implementations, inputs to the CNN correspond to a variety of other types of data, such as data obtained from different devices and sensors of a vehicle, point cloud data, audio data that includes certain features or raw audio at each of multiple time steps, or various types of one-dimensional or multiple dimensional data. A convolutional layer of the CNN can process the inputs to transform features of the image that are represented by inputs of the data structure. For example, the inputs are processed by performing dot product operations using input data along a given dimension of the data structure and a set of parameters for the convolutional layer.

Performing computations for a convolutional layer can include applying one or more sets of kernels to portions of inputs in the data structure. The manner in which CNN performs the computations can be based on specific properties for each layer of an example multi-layer neural network or deep neural network that supports deep neural net workloads. A deep neural network can include one or more convolutional towers (or layers) along with other computational layers. In particular, for example computer vision applications, these convolutional towers often account for a large proportion of the inference calculations that are performed. Convolutional layers of a CNN can have sets of artificial neurons that are arranged in three dimensions, a width dimension, a height dimension, and a depth dimension. The depth dimension corresponds to a third dimension of an input or activation volume and can represent respective color channels of an image. For example, input images can form an input volume of data (e.g., activations), and the volume has dimensions 32×32×3 (width, height, depth respectively). A depth dimension of 3 can correspond to the RGB color channels of red (R), green (G), and blue (B).

In general, layers of a CNN are configured to transform the three dimensional input volume (inputs) to a multi-dimensional output volume of neuron activations (activations). For example, a 3D input structure of 32×32×3 holds the raw pixel values of an example image, in this case an image of width 32, height 32, and with three color channels, R,G,B. A convolutional layer of a CNN of the machine learning model 320 computes the output of neurons that may be connected to local regions in the input volume. Each neuron in the convolutional layer can be connected only to a local region in the input volume spatially, but to the full depth (e.g., all color channels) of the input volume. For a set of neurons at the convolutional layer, the layer computes a dot product between the parameters (weights) for the neurons and a certain region in the input volume to which the neurons are connected. This computation may result in a volume such as 32×32×12, where 12 corresponds to a number of kernels that are used for the computation. A neuron's connection to inputs of a region can have a spatial extent along the depth axis that is equal to the depth of the input volume. The spatial extent corresponds to spatial dimensions (e.g., x and y dimensions) of a kernel.

A set of kernels can have spatial characteristics that include a width and a height and that extends through a depth of the input volume. Each set of kernels for the layer is applied to one or more sets of inputs provided to the layer. That is, for each kernel or set of kernels, the machine learning model 320 can overlay the kernel, which can be represented multi-dimensionally, over a first portion of layer inputs (e.g., that form an input volume or input tensor), which can be represented multi-dimensionally. For example, a set of kernels for a first layer of a CNN may have size 5×5×3×16, corresponding to a width of 5 pixels, a height of 5 pixel, a depth of 3 that corresponds to the color channels of the input volume to which to a kernel is being applied, and an output dimension of 16 that corresponds to a number of output channels. In this context, the set of kernels includes 16 kernels so that an output of the convolution has a depth dimension of 16.

The machine learning model 320 can then compute a dot product from the overlapped elements. For example, the machine learning model 320 can convolve (or slide) each kernel across the width and height of the input volume and compute dot products between the entries of the kernel and inputs for a position or region of the image. Each output value in a convolution output is the result of a dot product between a kernel and some set of inputs from an example input tensor. The dot product can result in a convolution output that corresponds to a single layer input, e.g., an activation element that has an upper-left position in the overlapped multi-dimensional space. As discussed above, a neuron of a convolutional layer can be connected to a region of the input volume that includes multiple inputs. The machine learning model 320 can convolve each kernel over each input of an input volume. The machine learning model 320 can perform this convolution operation by, for example, moving (or sliding) each kernel over each input in the region.

The machine learning model 320 can move each kernel over inputs of the region based on a stride value for a given convolutional layer. For example, when the stride is set to 1, then the machine learning model 320 can move the kernels over the region one pixel (or input) at a time. Likewise, when the stride is 2, then the machine learning model 320 can move the kernels over the region two pixels at a time. Thus, kernels may be shifted based on a stride value for a layer and the machine learning model 320 can repeatedly perform this process until inputs for the region have a corresponding dot product. Related to the stride value is a skip value. The skip value can identify one or more sets of inputs (2×2), in a region of the input volume, that are skipped when inputs are loaded for processing at a neural network layer. In some implementations, an input volume of pixels for an image can be “padded” with zeros, e.g., around a border region of an image. This zero-padding is used to control the spatial size of the output volumes.

As discussed previously, a convolutional layer of CNN is configured to transform a three dimensional input volume (inputs of the region) to a multi-dimensional output volume of neuron activations. For example, as the kernel is convolved over the width and height of the input volume, the machine learning model 320 can produce a multi-dimensional activation map that includes results of convolving the kernel at one or more spatial positions based on the stride value. In some cases, increasing the stride value produces smaller output volumes of activations spatially. In some implementations, an activation can be applied to outputs of the convolution before the outputs are sent to a subsequent layer of the CNN.

An example convolutional layer can have one or more control parameters for the layer that represent properties of the layer. For example, the control parameters can include a number of kernels, K, the spatial extent of the kernels, F, the stride (or skip), S, and the amount of zero padding, P. Numerical values for these parameters, the inputs to the layer, and the parameter values of the kernel for the layer shape the computations that occur at the layer and the size of the output volume for the layer. In some implementations, the spatial size of the output volume is computed as a function of the input volume size, W, using the formula (W?F+2P)/S+1. For example, an input tensor can represent a pixel input volume of size [227×227×3]. A convolutional layer of a CNN can have a spatial extent value of F=11, a stride value of S=4, and no zero-padding (P=0). Using the above formula and a layer kernel quantity of K=96, the machine learning model 320 performs computations for the layer that results in a convolutional layer output volume of size [55×55×96], where 55 is obtained from [(227-11+0)/4+1=55].

The computations (e.g., dot product computations) for a convolutional layer, or other layers, of a CNN involve performing mathematical operations, e.g., multiplication and addition, using a computation unit of a hardware circuit of the machine learning model 320. The design of a hardware circuit can cause a system to be limited in its ability to fully utilize computing cells of the circuit when performing computations for layers of a neural network.

FIG. 4 illustrates an example flow diagram for an identification module of the system of FIG. 2. The method 360 is implemented with the feed gas prediction module 144 monitoring upstream flow volumes, input flows, and operating conditions. The feed gas prediction module 144 includes one or more machine learning models based on historical data associating upstream flow volumes, input flows, and operating conditions with clients and characteristics of feed gas. A prototype of the feed gas prediction module 144 has been developed using upstream flow volumes, input flows, and operating conditions from a central processing facility including an NGL plant in Saudi Arabia.

The monitoring process includes obtaining upstream flow volumes, input flows, and operating conditions for a first time period and a second time period (step 372). The machine learning models of the feed gas prediction module 144 determine one or more features to extract from the upstream flow volumes, input flows, and operating conditions (step 374). These features represent physical features of a refinery complex for each of the first time period and the second time period. The features are extracted from the images to form a first feature vector for the first time period and a second feature vector for the second time period (step 376).

The feed gas prediction module 144 includes one or machine learning models trained with labeled upstream flow volumes, input flows, and operating conditions data representing refinery complex conditions in the historic data. The labeled image data associates upstream flow volumes, input flows, and operating conditions with volumes and characteristics of feed gas in the first and second vectors. Although the prototype of the feed gas prediction module 144 was trained on data from a specific facility, the feed gas prediction module 144 can be trained on data from other facilities with compressors. The methodology can also be used whenever there is a distribution of feed to multiple equipment such as multiple GOSPs (Gas Oil Separation Plant)

A specific machine learning model is selected based on the one or more features included in the first feature vector and the second feature vector. The selected machine learning model processes the first feature vector and the second feature vector (step 378) and determines, based on the processing, volumes and characteristics of feed gas (step 380). The results of this process (i.e., volumes and characteristics of feed gas) are stored in the data store 150 in association with the upstream flow volumes, input flows, and operating conditions (step 382).

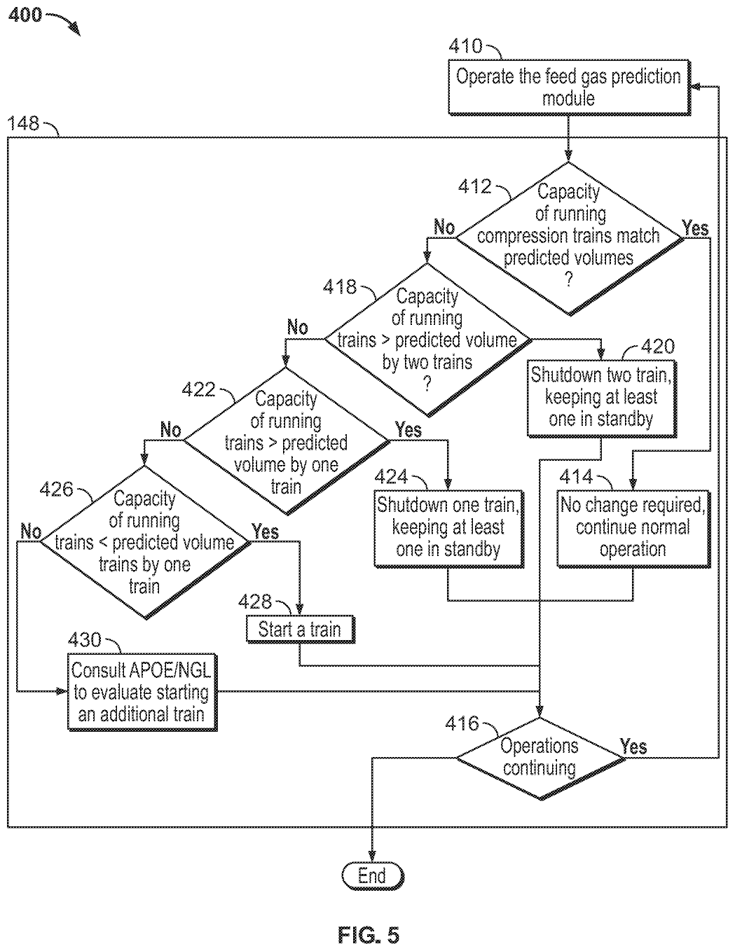

FIG. 5 illustrates operations 400 of the compressor operation module 148. After the feed gas prediction module 144 is operated as discussed above (step 410), the results are provided to the compressor operation module 148. The capacity of the running compression trains is compared to the predicted feed gas volumes (step 412). If the capacity of the running compression trains matches the predicted feed gas volume, no changes required in normal operations are continued (step 414). The compression operation module 148 then checks if operations are continuing (step 416).

If the capacity of the running compression trains does not match the predicted feed gas volume, the compressor operation module 148 checks whether the capacity of the running compression trains is greater than the predicted feed gas volume by the capacity of one compression train (step 418). If the capacity of the running compression trains is greater than the predicted feed gas volume by the capacity of two compression trains, the compressor operation module 148 indicates that two compression trains should be shut down, leaving at least one compression train in standby (step 420). The compression operation module 148 then checks if operations are continuing (step 416). If the capacity of the running compression trains is not greater than the predicted feed gas volume by the capacity of two compression trains, the compressor operation module 148 checks whether the capacity of the running compression trains is greater than the predicted feed gas volume by the capacity of one compression train (step 422).

If the capacity of the running compression trains is greater than the predicted feed gas volume by the capacity of one compression train, the compressor operation module 148 indicates that one compression trains should be shut down, leaving at least one compression train in standby (step 424). The compression operation module 148 then checks if operations are continuing (step 416). If the capacity of the running compression trains is not greater than the predicted feed gas volume by the capacity of one compression train, the compressor operation module 148 checks whether the capacity of the running compression trains is less than the predicted feed gas volume by the capacity of one compression train (step 426).

If the capacity of the running compression trains is less than the predicted feed gas volume by the capacity of one compression train, the compressor operation module 148 indicates that one compression trains should be started up (step 428). The compression operation module 148 then checks if operations are continuing (step 416). If the capacity of the running compression trains is not less than the predicted feed gas volume by the capacity of one compression train, the compressor operation module 148 indicates that the engineering unit in NGL plants needs to evaluate starting a second train since sometimes the recycle rate is high and reducing the recycle rate to accommodate more feed gas can be implemented rather than starting an additional train. This option was included to avoid starting an additional train unnecessarily as reducing the recycle rate can work smoothly to provide the desired capacity. The compression operation module 148 then checks if operations are continuing (step 416).

If operations are continuing, the compressor operation module 148 activates the feed gas predictions module 144. If operations are not continuing, the compressor operation module 148 ends.

As discussed above, this approach was used to develop a prototype system for a specific refinery complex and its NGL plant. Data on upstream flow volumes, input flows, and operating conditions including gas condensate, ambient temperature and H₂S readings were collected and cleaned. A multi linear regression model was developed using backward selection to determine the predictors that have a significant impact on the incoming feed gas to the NGL plant. All variables were initially included and then a P-value test was used to remove the predictors that aren't significant in predicting the response or the incoming feed gas. For the sake of having high accurate model, P-value used was <5%. More specifically, if the P-value exceeded the 5% for a specific predictor, the predictors was removed as not significantly affect the incoming feed gas. Table 1 shows the final model result and as shown in the below table P-value for all predictors is <5% by far. In addition, as shown in Table 2, R² for the model was 95.6% indicating that the model is very accurate in predicting the incoming feed gas volume to the NGL plant.

TABLE 1

| | | Standard | | |
|---|---|---|---|---|
| | Coefficients (B_{#}) | Error | t Stat | P-value |
| Intercept | 68.09573907 | 9.589333944 | 7.101196 | 3.07713E−11 |
| Incoming-Crude | 0.096409231 | 0.007717515 | 12.49226 | 6.14681E−26 |
| (ospas)-AVG (X₁) | | | | |
| AXL-TOTAL- | 0.134117986 | 0.01020393 | 13.14376 | 8.27282E−28 |
| INCOMING-AVG (X₂) | | | | |
| AL-TOTAL- | 0.02464668 | 0.007697444 | 3.20193 | 0.00162478 |
| INCOMING-AVG (X₃) | | | | |
| 102-QA-4 - AXL belnd- | −1.118837425 | 0.108870675 | −10.2768 | 1.2232E−19 |
| H2S (X₄) | | | | |
| 120-R/D A-H2S (X₅) | −1.495133499 | 0.064074191 | −23.3344 | 2.53563E−55 |
| LP/IP-Gas-From- | −3.485479747 | 0.140666601 | −24.7783 | 8.44064E−59 |
| GOSPs-5&6-AVG (X₆) | | | | |

TABLE 2
Regression Statistics

| | |
|---|---|
| Multiple R | 0.97736564 |
| R Square | 0.955243594 |
| Adjusted R Square | 0.953691349 |
| Standard Error | 11.71714133 |
| Observations | 180 |

Based on the results shown in Table 1 and Table 2, the final selection of the predictors which significantly impact the incoming feed gas to the modeled NGL plant was total incoming crude rate, total AL incoming, total AXL incoming, IP/LP as well as the stabilization depth in the North and South stabilizer. The stabilization depth is the H₂S readings which are changed based on customer requirements in oil plants. For example, if customer wants less H₂S in the exported crude rate, the reboilers in the oil plants will be operated at higher temperature to reduce the H₂S in the crude rate. This means high feed gas is coming to NGL plants and vice versa. Application of machine learning techniques resulted in the following equation for feed gas to the NGL plant.

Incoming feed gas=B₀+X₁*B₁+X₂*B₂+X₃*B₃+X₄*B₄+X₅*B₅+X₆*B₆

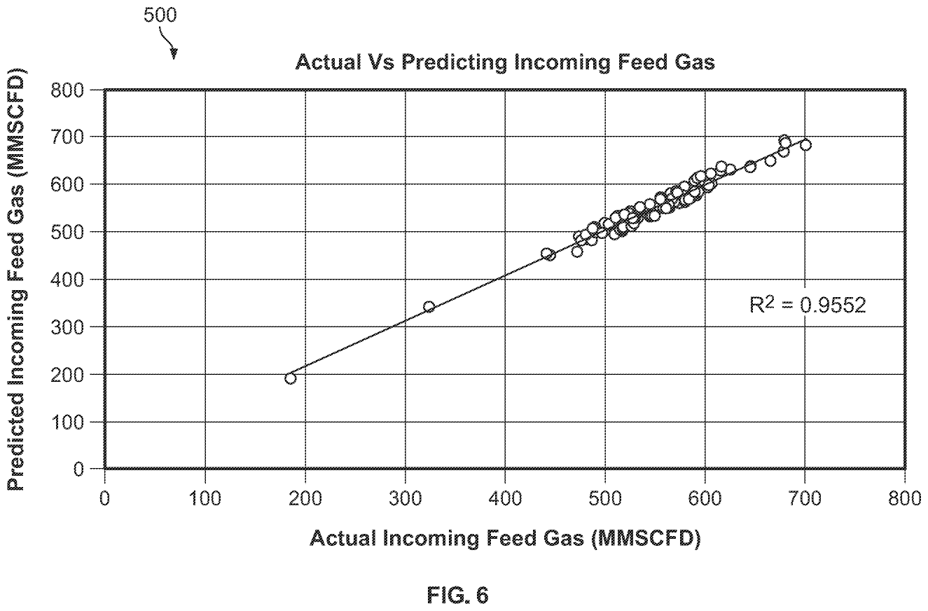

FIG. 6 shows the regression model output using the training data set. This chart 500 compares actual and predicted incoming feed gas volumes of generated by the feed gas prediction module of a prototype system using the training data set.

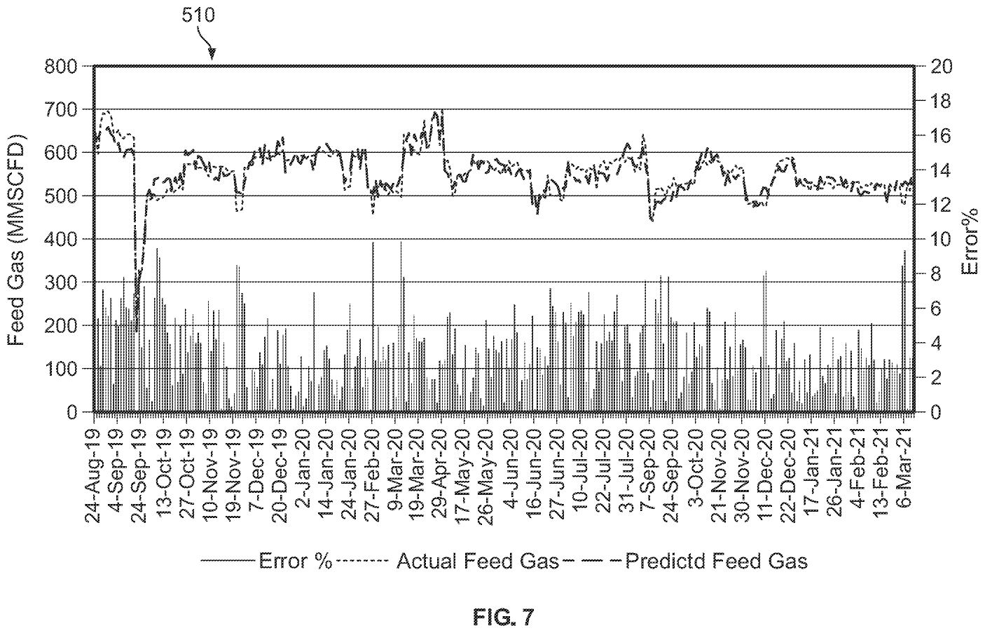

FIG. 7 shows the regression model output being checked using the testing data set. This chart 510 compares actual and predicted incoming feed gas volumes of generated by the feed gas prediction module of the prototype system using the testing data set. As shown in FIG. 7, the predicted incoming feed gas values match the actual incoming seed gas for a wider range of data with an average prediction accuracy reaching ˜95%.

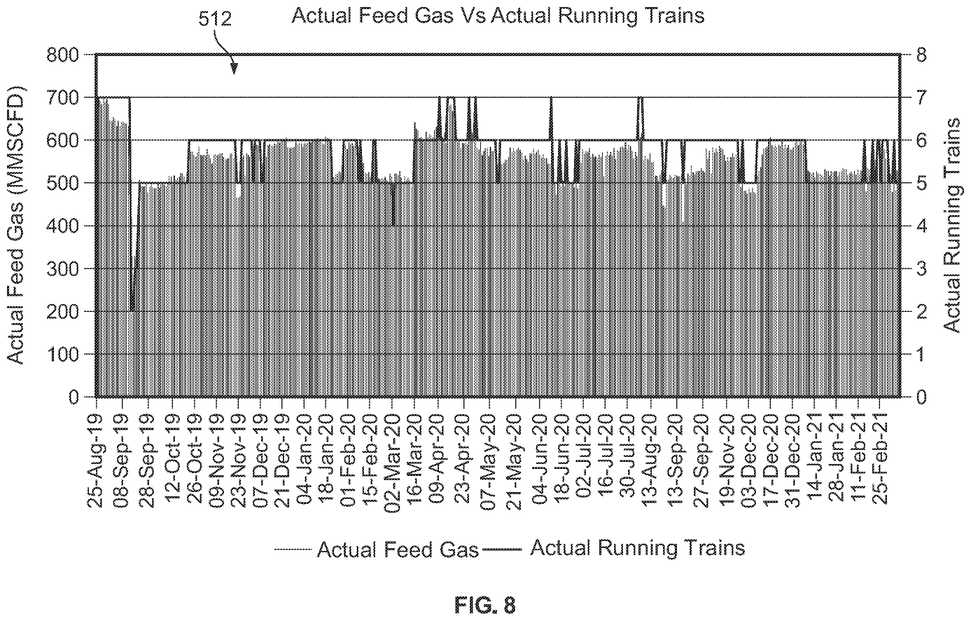

FIGS. 8-10 illustrate the significance of using the predicted feed gas volumes to control compressor trains in the NGL plant. In particular, the results of the feed gas prediction module 144 allow operators to calculate the optimum recycle amount as well as the optimum number of running trains to accommodate the predicted incoming feed gas.

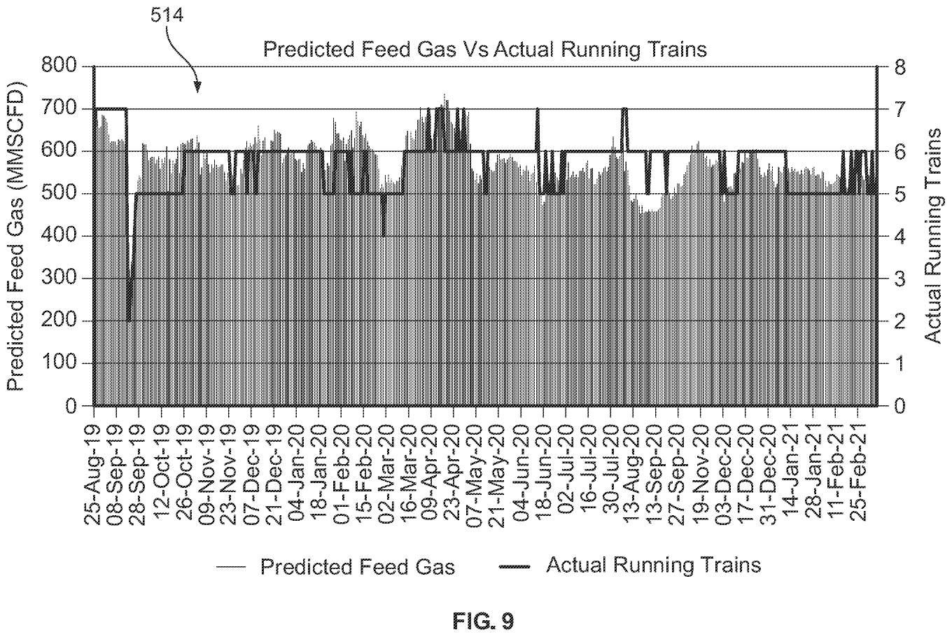

FIG. 8 is a chart comparing actual incoming feed gas and the capacity of actual running compression trains. This chart 512 shows the total incoming feed gas vs running trains from September 2019 to March 2021 for the NGL plant being modeled using the prototype. The gaps between the capacity of the running trains and the feed gas volumes indicate occasions when the running trains exceeded the required capacity needed to process the incoming feed gas. FIG. 9 is a chart 514 comparing predicted incoming feed gas and the capacity of actual running compression trains and shows similar results.

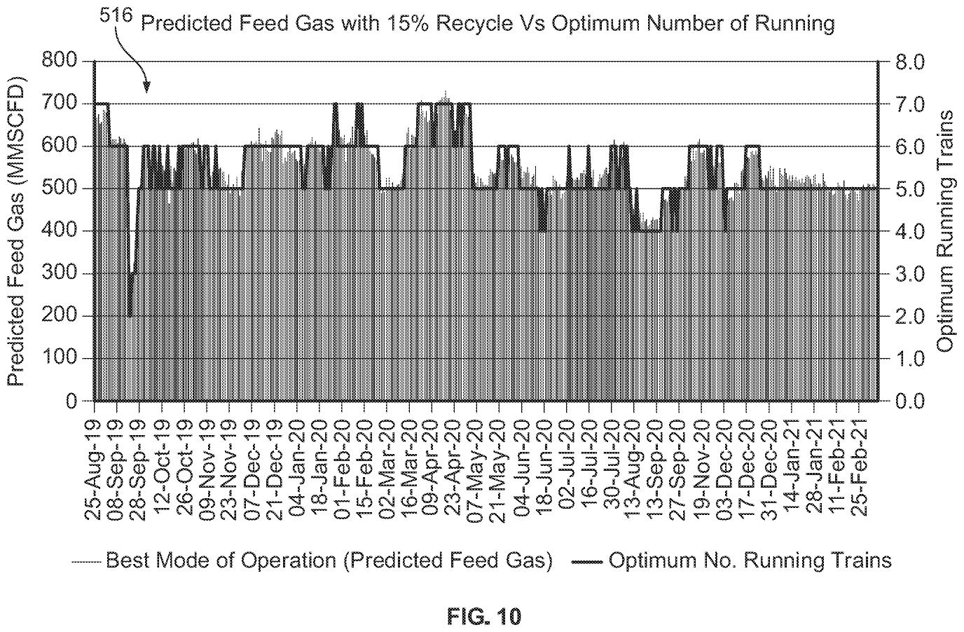

FIG. 10 is a chart 516 showing the number of compression trains that would achieve peak efficiency for the predicted incoming feed gas with a 15% recycle rate. The recycle rate is 15% is the set KPI set to the facility used to test the prototype but can be changed based on the facility requirements. For example, the 15% recycle in the test facility provides enough capacity to substantially account for tripping of one of the compressor. In such scenario, the recycle rate can be reduced to as a minimum to accommodate the excess feed gas resulted from the trip of the compressor and avoid flaring.

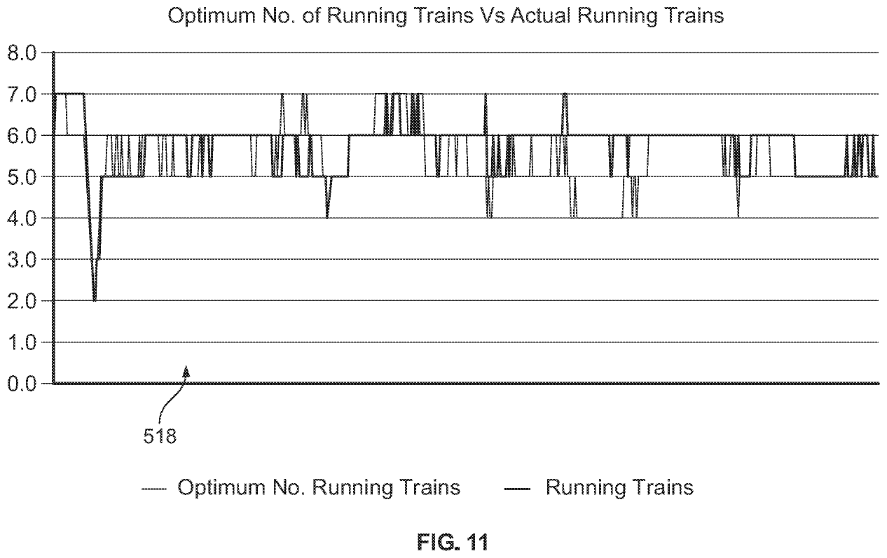

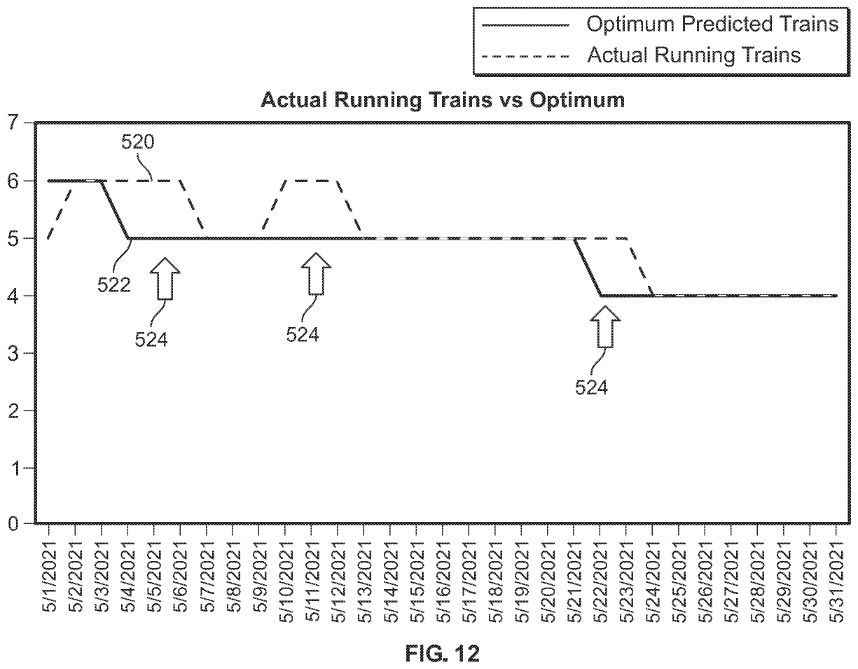

FIG. 11 is a chart 518 that compares the actual running compression trains and the capacity of compression trains that would be operated based results of the compressor operation module of the prototype system. FIG. 12 compares the number 520 of actual running compression trains and the number 522 of compression trains that would achieve peak efficiency for the predicted incoming feed gas based on results of the compressor operation module of the prototype system. The arrows 524 indicate periods when more compression trains were running than necessary.

Extrapolated over a year, these results indicate that shutting the extra compression trains down can provide: fuel gas reduction of around 810 MMSCF/year (equivalent to a cost avoidance of around $2.85 MM); emission reductions of around 46 M tons/year; a 20% reduction of running trains and associated wear-and-tear and maintenance requirements; and reductions in uncertainty regarding planning strategy and plant operations.

FIG. 12 is a block diagram of an example computer system 600 used to provide computational functionalities associated with described algorithms, methods, functions, processes, flows, and procedures described in the present disclosure, according to some implementations of the present disclosure. The illustrated computer 602 is intended to encompass any computing device such as a server, a desktop computer, a laptop/notebook computer, a wireless data port, a smart phone, a personal data assistant (PDA), a tablet computing device, or one or more processors within these devices, including physical instances, virtual instances, or both. The computer 602 can include input devices such as keypads, keyboards, and touch screens that can accept user information. Also, the computer 602 can include output devices that can convey information associated with the operation of the computer 602. The information can include digital data, visual data, audio information, or a combination of information. The information can be presented in a graphical user interface (UI) (or GUI).

The computer 602 can serve in a role as a client, a network component, a server, a database, a persistency, or components of a computer system for performing the subject matter described in the present disclosure. The illustrated computer 602 is communicably coupled with a network 630. In some implementations, one or more components of the computer 602 can be configured to operate within different environments, including cloud-computing-based environments, local environments, global environments, and combinations of environments.

At a high level, the computer 602 is an electronic computing device operable to receive, transmit, process, store, and manage data and information associated with the described subject matter. According to some implementations, the computer 602 can also include, or be communicably coupled with, an application server, an email server, a web server, a caching server, a streaming data server, or a combination of servers.

The computer 602 can receive requests over network 630 from a client application (for example, executing on another computer 602). The computer 602 can respond to the received requests by processing the received requests using software applications. Requests can also be sent to the computer 602 from internal users (for example, from a command console), external (or third) parties, automated applications, entities, individuals, systems, and computers.

Each of the components of the computer 602 can communicate using a system bus 603. In some implementations, any or all of the components of the computer 602, including hardware or software components, can interface with each other or the interface 604 (or a combination of both), over the system bus 603. Interfaces can use an application programming interface (API) 612, a service layer 613, or a combination of the API 612 and service layer 613. The API 612 can include specifications for routines, data structures, and object classes. The API 612 can be either computer-language independent or dependent. The API 612 can refer to a complete interface, a single function, or a set of APIs.

The service layer 613 can provide software services to the computer 602 and other components (whether illustrated or not) that are communicably coupled to the computer 602. The functionality of the computer 602 can be accessible for all service consumers using this service layer. Software services, such as those provided by the service layer 613, can provide reusable, defined functionalities through a defined interface. For example, the interface can be software written in JAVA, C++, or a language providing data in extensible markup language (XML) format. While illustrated as an integrated component of the computer 602, in alternative implementations, the API 612 or the service layer 613 can be stand-alone components in relation to other components of the computer 602 and other components communicably coupled to the computer 602. Moreover, any or all parts of the API 612 or the service layer 613 can be implemented as child or sub-modules of another software module, enterprise application, or hardware module without departing from the scope of the present disclosure.

The computer 602 includes an interface 604. Although illustrated as a single interface 604 in FIG. 6, two or more interfaces 604 can be used according to particular needs, desires, or particular implementations of the computer 602 and the described functionality. The interface 604 can be used by the computer 602 for communicating with other systems that are connected to the network 630 (whether illustrated or not) in a distributed environment. Generally, the interface 604 can include, or be implemented using, logic encoded in software or hardware (or a combination of software and hardware) operable to communicate with the network 630. More specifically, the interface 604 can include software supporting one or more communication protocols associated with communications. As such, the network 630 or the interface's hardware can be operable to communicate physical signals within and outside of the illustrated computer 602.

The computer 602 includes a processor 605. Although illustrated as a single processor 605 in FIG. 6, two or more processors 605 can be used according to particular needs, desires, or particular implementations of the computer 602 and the described functionality. Generally, the processor 605 can execute instructions and can manipulate data to perform the operations of the computer 602, including operations using algorithms, methods, functions, processes, flows, and procedures as described in the present disclosure.

The computer 602 also includes a database 606 that can hold data for the computer 602 and other components connected to the network 630 (whether illustrated or not). For example, database 606 can be an in-memory, conventional, or a database storing data consistent with the present disclosure. In some implementations, database 606 can be a combination of two or more different database types (for example, hybrid in-memory and conventional databases) according to particular needs, desires, or particular implementations of the computer 602 and the described functionality. Although illustrated as a single database 606 in FIG. 6, two or more databases (of the same, different, or combination of types) can be used according to particular needs, desires, or particular implementations of the computer 602 and the described functionality. While database 606 is illustrated as an internal component of the computer 602, in alternative implementations, database 606 can be external to the computer 602.

The computer 602 also includes a memory 607 that can hold data for the computer 602 or a combination of components connected to the network 630 (whether illustrated or not). Memory 607 can store any data consistent with the present disclosure. In some implementations, memory 607 can be a combination of two or more different types of memory (for example, a combination of semiconductor and magnetic storage) according to particular needs, desires, or particular implementations of the computer 602 and the described functionality. Although illustrated as a single memory 607 in FIG. 6, two or more memories 607 (of the same, different, or combination of types) can be used according to particular needs, desires, or particular implementations of the computer 602 and the described functionality. While memory 607 is illustrated as an internal component of the computer 602, in alternative implementations, memory 607 can be external to the computer 602.

The application 608 can be an algorithmic software engine providing functionality according to particular needs, desires, or particular implementations of the computer 602 and the described functionality. For example, application 608 can serve as one or more components, modules, or applications. Further, although illustrated as a single application 608, the application 608 can be implemented as multiple applications 608 on the computer 602. In addition, although illustrated as internal to the computer 602, in alternative implementations, the application 608 can be external to the computer 602.

The computer 602 can also include a power supply 614. The power supply 614 can include a rechargeable or non-rechargeable battery that can be configured to be either user- or non-user-replaceable. In some implementations, the power supply 614 can include power-conversion and management circuits, including recharging, standby, and power management functionalities. In some implementations, the power-supply 614 can include a power plug to allow the computer 602 to be plugged into a wall socket or a power source to, for example, power the computer 602 or recharge a rechargeable battery.

There can be any number of computers 602 associated with, or external to, a computer system containing computer 602, with each computer 602 communicating over network 630. Further, the terms “client,” “user,” and other appropriate terminology can be used interchangeably, as appropriate, without departing from the scope of the present disclosure. Moreover, the present disclosure contemplates that many users can use one computer 602 and one user can use multiple computers 602.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs. Each computer program can include one or more modules of computer program instructions encoded on a tangible, non transitory, computer-readable computer-storage medium for execution by, or to control the operation of, data processing apparatus. Alternatively, or additionally, the program instructions can be encoded in/on an artificially generated propagated signal. The example, the signal can be a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus,” “computer,” and “electronic computer device” (or equivalent as understood by one of ordinary skill in the art) refer to data processing hardware. For example, a data processing apparatus can encompass all kinds of apparatus, devices, and machines for processing data, including by way of example, a programmable processor, a computer, or multiple processors or computers. The apparatus can also include special purpose logic circuitry including, for example, a central processing unit (CPU), a field programmable gate array (FPGA), or an application specific integrated circuit (ASIC). In some implementations, the data processing apparatus or special purpose logic circuitry (or a combination of the data processing apparatus or special purpose logic circuitry) can be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, for example LINUX, UNIX, WINDOWS, MAC OS, ANDROID, or IOS.

A computer program, which can also be referred to or described as a program, software, a software application, a module, a software module, a script, or code, can be written in any form of programming language. Programming languages can include, for example, compiled languages, interpreted languages, declarative languages, or procedural languages. Programs can be deployed in any form, including as stand-alone programs, modules, components, subroutines, or units for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files storing one or more modules, sub programs, or portions of code. A computer program can be deployed for execution on one computer or on multiple computers that are located, for example, at one site or distributed across multiple sites that are interconnected by a communication network. While portions of the programs illustrated in the various figures may be shown as individual modules that implement the various features and functionality through various objects, methods, or processes, the programs can instead include a number of sub-modules, third-party services, components, and libraries. Conversely, the features and functionality of various components can be combined into single components as appropriate. Thresholds used to make computational determinations can be statically, dynamically, or both statically and dynamically determined.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computers suitable for the execution of a computer program can be based on one or more of general and special purpose microprocessors and other kinds of CPUs. The elements of a computer are a CPU for performing or executing instructions and one or more memory devices for storing instructions and data. Generally, a CPU can receive instructions and data from (and write data to) a memory. A computer can also include, or be operatively coupled to, one or more mass storage devices for storing data. In some implementations, a computer can receive data from, and transfer data to, the mass storage devices including, for example, magnetic, magneto optical disks, or optical disks. Moreover, a computer can be embedded in another device, for example, a mobile telephone, a personal digital assistant (PDA), a mobile audio or video player, a game console, a global positioning system (GPS) receiver, or a portable storage device such as a universal serial bus (USB) flash drive.

Computer readable media (transitory or non-transitory, as appropriate) suitable for storing computer program instructions and data can include all forms of permanent/non-permanent and volatile/non-volatile memory, media, and memory devices. Computer readable media can include, for example, semiconductor memory devices such as random access memory (RAM), read only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Computer readable media can also include, for example, magnetic devices such as tape, cartridges, cassettes, and internal/removable disks. Computer readable media can also include magneto optical disks and optical memory devices and technologies including, for example, digital video disc (DVD), CD ROM, DVD+/−R, DVD-RAM, DVD-ROM, HD-DVD, and BLURAY. The memory can store various objects or data, including caches, classes, frameworks, applications, modules, backup data, jobs, web pages, web page templates, data structures, database tables, repositories, and dynamic information. Types of objects and data stored in memory can include parameters, variables, algorithms, instructions, rules, constraints, and references. Additionally, the memory can include logs, policies, security or access data, and reporting files. The processor and the memory can be supplemented by, or incorporated in, special purpose logic circuitry.

Implementations of the subject matter described in the present disclosure can be implemented on a computer having a display device for providing interaction with a user, including displaying information to (and receiving input from) the user. Types of display devices can include, for example, a cathode ray tube (CRT), a liquid crystal display (LCD), a light-emitting diode (LED), and a plasma monitor. Display devices can include a keyboard and pointing devices including, for example, a mouse, a trackball, or a trackpad. User input can also be provided to the computer through the use of a touchscreen, such as a tablet computer surface with pressure sensitivity or a multi-touch screen using capacitive or electric sensing. Other kinds of devices can be used to provide for interaction with a user, including to receive user feedback including, for example, sensory feedback including visual feedback, auditory feedback, or tactile feedback. Input from the user can be received in the form of acoustic, speech, or tactile input. In addition, a computer can interact with a user by sending documents to, and receiving documents from, a device that is used by the user. For example, the computer can send web pages to a web browser on a user's client device in response to requests received from the web browser.

The term “graphical user interface,” or “GUI,” can be used in the singular or the plural to describe one or more graphical user interfaces and each of the displays of a particular graphical user interface. Therefore, a GUI can represent any graphical user interface, including, but not limited to, a web browser, a touch screen, or a command line interface (CLI) that processes information and efficiently presents the information results to the user. In general, a GUI can include a plurality of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back end component, for example, as a data server, or that includes a middleware component, for example, an application server. Moreover, the computing system can include a front-end component, for example, a client computer having one or both of a graphical user interface or a Web browser through which a user can interact with the computer. The components of the system can be interconnected by any form or medium of wireline or wireless digital data communication (or a combination of data communication) in a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) (for example, using 802.11 a/b/g/n or 802.20 or a combination of protocols), all or a portion of the Internet, or any other communication system or systems at one or more locations (or a combination of communication networks). The network can communicate with, for example, Internet Protocol (IP) packets, frame relay frames, asynchronous transfer mode (ATM) cells, voice, video, data, or a combination of communication types between network addresses.

The computing system can include clients and servers. A client and server can generally be remote from each other and can typically interact through a communication network. The relationship of client and server can arise by virtue of computer programs running on the respective computers and having a client-server relationship.

Cluster file systems can be any file system type accessible from multiple servers for read and update. Locking or consistency tracking may not be necessary since the locking of exchange file system can be done at application layer. Furthermore, Unicode data files can be different from non-Unicode data files.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

A number of embodiments of these systems and methods have been described. Nevertheless, it will be understood that various modifications may be made without departing from the spirit and scope of this disclosure. Accordingly, other embodiments are within the scope of the following claims.

What is claimed is:

1. A method for operating a natural gas liquids (NGL) plant, the method comprising:
(a) obtaining upstream flow volumes, input flows, and operating conditions of a refinery complex including the NGL plant for a first time period and a second time period;
(b) determining one or more features to extract from the upstream flow volumes, input flows, and operating conditions for each of the first time period and the second time period;
(c) extracting the one or more features from the upstream flow volumes, input flows, and operating conditions of the NGL to form a first feature vector for the first time period and a second feature vector for the second time period;
(d) processing the first feature vector and the second feature vector using a machine learning model, the machine learning model being trained with labeled data representing incoming feed gas of the NGL, the labeled data associating upstream flow volumes, input flows, and operating conditions with incoming feed gas volumes; and
(e) determining, based on the processing, predicted incoming feed gas volumes.

2. The method of claim 1, wherein obtaining upstream flow volumes, input flows, and operating conditions of the NGL plant comprises obtaining condensate, ambient temperature and H2S readings.

3. The method of claim 1, further comprising controlling operation of compressors of the NGL plant based on the predicted incoming feed gas volumes.

4. The method of claim 3, wherein controlling operation of compressors of the NGL plant based on the predicted incoming feed gas volumes comprises shutting down at least one compression train if the capacity of running compression trains exceeds the predicted incoming feed gas by the capacity of at least one compression train.

5. The method of claim 4, wherein controlling operation of compressors of the NGL plant based on the predicted incoming feed gas volumes comprises starting up at least one compression train if the capacity of running compression trains is less than the predicted incoming feed gas by the capacity of at least one compression train.

6. The method of claim 1, further comprising evaluating starting a second train by assessing whether reducing the recycle rate can provide needed additional capacity.

7. The method of claim 1, further comprising periodically updating feature vectors based new upstream flow volumes, input flows, and operating conditions of the NGL.

8. The method of claim 1, further comprising repeating step (e) while plant operations are continuing.

9. A method for operating a natural gas liquids (NGL) plant, the method comprising:
(a) applying a supervised machine learning model to upstream flow volumes, input flows, and operating conditions of the NGL plant for a first time period, the upstream flow volumes, input flows, and operating conditions being associated with incoming feed gas volumes to develop a model predicting incoming feed gas volumes based on a subset of features from the upstream flow volumes, input flows, and operating conditions of the NGL plant;
(b) extracting the subset of features from the upstream flow volumes, input flows, and operating conditions of the NGL for a second time period to predict incoming feed gas volumes; and
(f) controlling operation of compressors of the NGL plant based on the predicted incoming feed gas volumes.

10. The method of claim 9, wherein upstream flow volumes, input flows, and operating conditions of the NGL plant include at least condensate, ambient temperature and H2S readings.

11. The method of claim 10, wherein controlling operation of compressors of the NGL plant based on the predicted incoming feed gas volumes comprises shutting down at least one compression train if the capacity of running compression trains exceeds the predicted incoming feed gas by the capacity of at least one compression train.

12. The method of claim 11, wherein controlling operation of compressors of the NGL plant based on the predicted incoming feed gas volumes comprises starting up at least one compression train if the capacity of running compression trains is less than the predicted incoming feed gas by the capacity of at least one compression train.

13. The method of claim 9, further comprising evaluating starting a second train by assessing whether reducing the recycle rate can provide needed additional capacity.

14. The method of claim 9, further comprising periodically updating feature vectors based new upstream flow volumes, input flows, and operating conditions of the NGL.
